(19) United States
(12) Patent Application Publication
(10) Pub. No.: US 2008/0265203 A1
(43) Pub. Date: Oct. 30, 2008

(54) Refrigerating Machine Oil of a Compressor

(75) Inventors: Sung Jin Hwang, Kyeongsangnam-do (KR); Ju Ho Ock, Kyeongsangnam-do (KR); Kam Gyu Lee, Pusan-si (KR)

Correspondence Address: KED & ASSOCIATES, LLP, P.O. Box 221200, Chantilly, VA, 20153-1200, US

(73) Assignee: LG ELECTRONICS, INC., Seoul (KR)

(21) Appl. No.: 10/594,672

(22) PCT Filed: Aug. 9, 2005
(86) PCT No.: PCT/KR2005/002585

§ 371 Date: Jul. 14, 2008

(51) Int. Cl. C09K 5/04

(52) U.S. Cl. 252/68

(57) ABSTRACT

There is provided a refrigerating machine oil for a compressor. The oil includes a lubricating oil applied on frictional surfaces to reduce friction thereon and less than 1.0 wt % of a carbon nano particles.

### TECHNICAL FIELD

The present invention relates to a refrigerating machine oil, and more particularly, to a refrigerating machine oil for a compressor with nano additives to achieve superior performance.

### BACKGROUND ART

Compressors are refrigerating system components used for compressing refrigerant. They are installed and used in refrigerators, freezers, air conditioners, cold beverage and ice cream vending machines, etc.

Refrigerating systems include a compressor for converting a vaporized coolant of a low temperature and low pressure into one having a high temperature and high pressure, a condenser for transforming the high-temperature and high-pressure vaporized coolant converted by the compressor into a liquid form having a high temperature and high pressure, an expander for transforming the high-temperature and high-pressure liquid coolant from the condenser to a low-temperature and low-pressure liquid coolant, and an evaporator for transforming the low-temperature and low-pressure liquid coolant from the expander to a vapor form that absorbs heat from the outside.

The above refrigerating system is a closed circuit structure that circulates coolant through coolant passages to transform into the various physical forms described above. Specifically, the coolant as the operating fluid of the refrigerating system is a transport medium that absorbs heat from a low temperature material and transfers it to a high temperature material. Refrigerants commonly used now include ammonia and chloroflourocarbon coolant (freon). A refrigerant with appropriate characteristics can be selected for optimum refrigeration efficiency, depending on the capacity of the refrigerating device and the type and applicability of the compressor.

Such a refrigerant circulates in the refrigerating cycle and is compressed by the compressor. The compressor is classified into a reciprocal compressor, a rotary compressor, and a linear compressor according to compression methods. In each one of these compression types, friction and wear are prominent during operation. Accordingly, a lubricant needs to be applied to areas of the compressor that are subject to friction, the lubricant commonly being machine oil. Such oil used to lubricate compressors is referred to as refrigerating machine oil.

In more detail, refrigerating machine oil lubricates and reduces wear to a compressor's bearings, cylinders, and pistons, and also serves as a coolant to absorb heat produced by friction, seals shafts and piston rings, and prevents rust and corrosion, allowing the compressor to operate more reliably. Refrigerating machine oil is infused in refrigerant to co-circulate in the refrigerating cycle, so that its temperature changes in accordance with changes to the state of the refrigerant. Here, the refrigerating machine oil should not change chemically despite extreme temperature fluctuations thereof. Especially, refrigerating machine oil for use in a sealed compressor should have the characteristic of being a non-conductor of electricity.

Refrigerating machine oil should also retain a predetermined viscosity for maintaining its lubricating capability. That is, if the viscosity of refrigerating oil is too low, the oil is unable to lubricate; and if the viscosity is too high, the oil loses its sealing ability and leaks so that mechanical efficiency is compromised.

In the prior art, oil was used by itself as refrigerating machine oil used in compressors, so that it could not fulfill the basic requirements of refrigerating machine oil.

### DISCLOSURE OF INVENTION

### Technical Problem

To solve these problems, the present invention provides an improved refrigerating machine oil with added carbon nano particles.

Another object of the present invention is to provide an ideal blend ratio of carbon nano particles to lubricating oil.

### Technical Solution

To achieve the above objects, there is provided a refrigerating machine oil for a compressor including: lubricating oil applied on frictional surfaces to reduce friction thereon; and less than 10 wt % of carbon nano particles.

### ADVANTAGEOUS EFFECTS

An advantage of the refrigerating oil for a compressor according to the present invention is that refrigerating performance of a refrigerating machine oil increases with the addition of fullerene.

In other words, unlike a conventional refrigerating machine oil consisting of only oil, the addition of fullerene provides a noticeable increase in abrasion resistance, extreme pressure endurance, and heat conductivity.

By mixing a carbon nano particulate such as fullerene in a percentage by weight of below 1.0% into an oil, optimal performance can be realized at an inexpensive price.

When refrigerating machine oil adequately performs its function in a compressor, an overall increase in performance of the refrigerating cycle can be realized.

### BRIEF DESCRIPTION OF THE DRAWINGS

The spirit of the present invention can be understood more fully with reference to the accompanying drawings. In the drawings:

FIG. 1 is a perspective view showing an ultrasonic disperser used for manufacturing refrigerating machining oil;

FIG. 2 is an exploded perspective view of a testing device used to determine abrasion resistance of refrigerating machine oil;

FIG. 3 shows tables illustrating abrasion resistance test results of oil according to mixed percentages of fullerene;

FIGS. 4 through 6 show extreme pressure test results of lubricating oil (4GSI) according to mixed percentages of fullerene;

FIG. 7 is a schematic circuit diagram for measuring heat conductivity of oil according to mixed percentages of fullerene; and

FIG. 8 is a graph showing heat conductivity of oil mixed with fullerene and carbon nanotubes.

### BEST MODE FOR CARRYING OUT THE INVENTION

Hereinafter, preferred embodiments of a refrigerating machine oil according to the present invention will be described in detail with reference to the accompanying drawings. While the present invention has been described and illustrated herein with reference to the preferred embodiments thereof, various modifications and variations can be made therein without departing from the spirit and scope of the invention. Thus, it is intended that the present invention covers the modifications and variations of this invention provided they come within the scope of the appended claims and their equivalents.

As described above, the compressor is a device for compressing refrigerant in a refrigerating cycle, the compressor including a refrigerating machine oil for lubrication. The refrigerating machine oil for the compressor of the present invention includes a lubricating oil for reducing friction between contacting mechanical parts and a carbon nano particulate of fullerene (C₆₀ or C₇₀).

In further detail, the term “nanostructured material” refers to any material that is made smaller than 100 nm in particle size through physical, chemical, or mechanical means. Applications for nanostructured materials not only include materials of reduced particle size due to manufacturing requirements, but also cases where the physical properties exhibited by particles reduced to a nanometric level (which differ from those of the same material having a micron-level particle size) are required.

More specifically, fullerene has a molecular structure with 20 hexagonal and 12 pentagonal elements, as in a soccer ball, and differs from other crystalline substances in that it lacks periodic characteristics, so that it cannot be observed with an X-axis diffraction or an electron axis diffraction method. In addition, in order to manufacture refrigerating machine oil, fullerene can be infused into lubricating oil through a variety of techniques, such as using an agitator or an ultrasonic dispersion device.

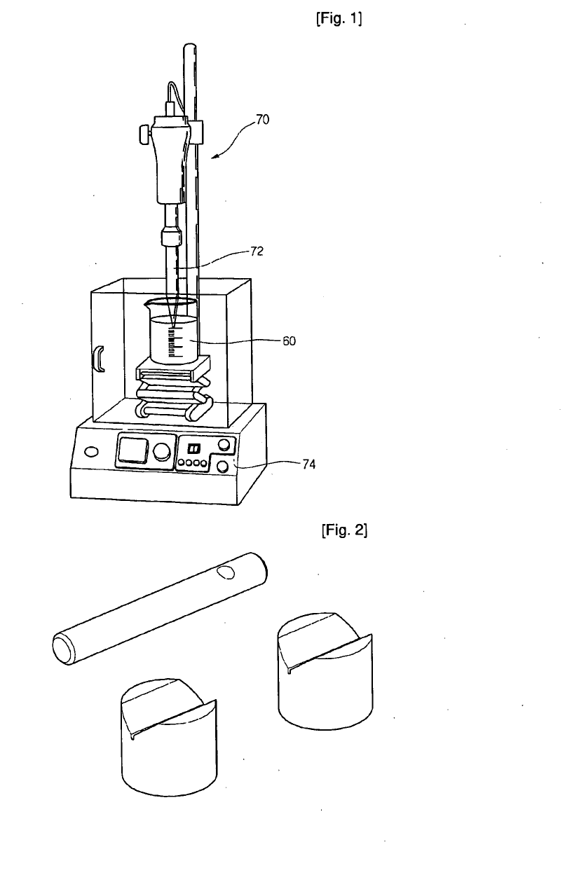

FIG. 1 is a is a perspective view showing an ultrasonic disperser used for manufacturing refrigerating machining oil.

Referring to FIG. 1, an ultrasonic disperser is a device used to mix or disperser substances that are difficult to mix.

In further detail, an ultrasonic disperser includes a piezoelectric ceramic and an ultrasonic oscillator, which uses an inverse piezoelectric effect to transform electrical energy into mechanical oscillation energy. The ultrasonic oscillator emits ultrasound through an oscillator, and amplifies the ultrasonic waves using a booster and horn on the oscillator. This type of ultrasonic disperser uses energy from the ultrasonic waves created by the oscillator and the horn, focusing the ultrasound into a liquid to create cavitation bubbles in the liquid.

Specifically, when the ultrasound is discharged into the liquid, the temperature and pressure of the cavitational bubbles created are high. When the bubbles expand and burst, shock waves of high temperature and pressure are created. Accordingly, an ultrasonic disperser is used to mix or disperse liquids that are difficult to mix.

For example, if lubricating oil and fullerene are poured into a flask 60 (as shown), the lower end of the beam 72 of the ultrasonic disperser is immersed in the mixture contained in the flask 60, the control panel portion 74 at the front of the apparatus is used to activate ultrasonic radiation, then the fullerene is thoroughly dispersed into the lubricating oil. Theoretically, nano-sized particles is dispersed into a liquid will remain indefinitely in suspension. Due to cohesiveness of nano materials, however, the diameters of particles enlarge, and sedimentation of particles accelerates. Nevertheless, when nano-sized fullerene is mixed into lubricating oil, a negligible amount of particle sedimentation occurs.

FIG. 2 is an exploded perspective view of a testing device used to determine abrasion resistance of refrigerating machine oil.

Referring to FIG. 2, a journal 80 and v-blocks 82 were used to conduct an abrasion resistance test. Specifically, the journal 80 was an AISI C-3135 steel having a rockwell hardness of 6 HRC, and the v-blocks 82 were AISI C-1137 steel having a rockwell hardness of 20-24 HRC.

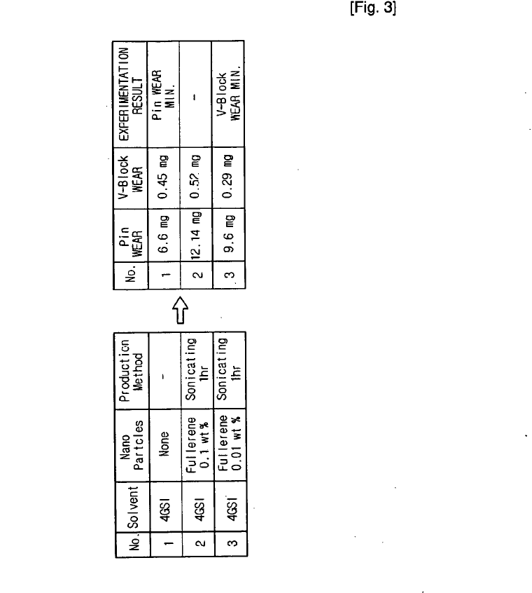

FIG. 3 shows tables illustrating abrasion resistance test results of oil according to mixed percentages of fullerene.

Referring to FIG. 3, the test was conducted with a 100 kgf load and a rotational speed of 290 rpm over a 1-hour duration.

In further detail, when a 0.1 wt % fullerene was added to 4GSI lubricating oil, the abrasion resistance actually declined in comparison to a refrigerating machine oil without additives; and a 0.01% fullerene added produced the best results (test #3), in which wear of the v-blocks 82 was minimal.

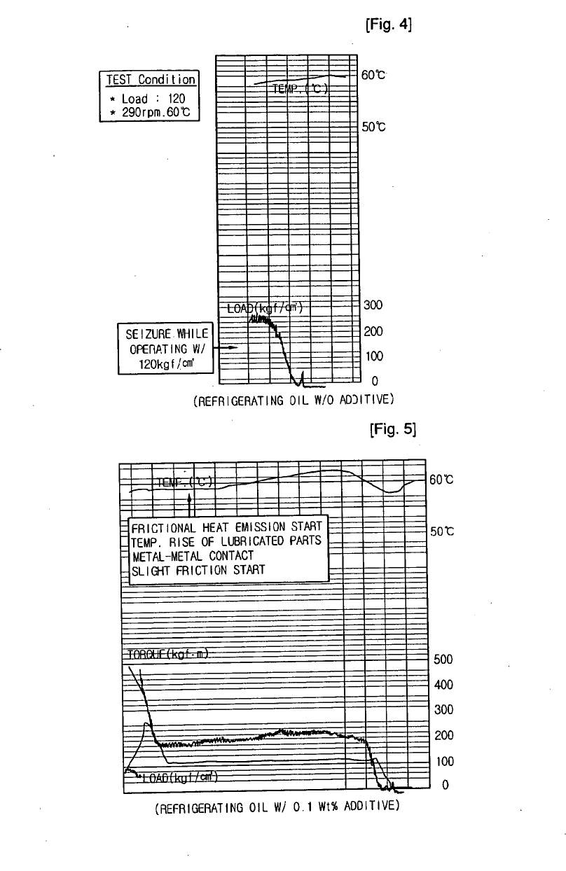

FIGS. 4 through 6 show extreme pressure test results of lubricating oil (4GSI) according to mixed percentages of fullerene.

FIG. 4 is a test result of refrigerating machine oil without additives, FIG. 5 is a test result of a 0.1 wt % fullerene added to refrigerating machine oil, and FIG. 6 is a test result of a 0.01 wt % fullerene added to refrigerating machine oil.

Referring to FIG. 4, the results of the extreme pressure test without fullerene added shows mechanical seizure occurring during operation with 120 kgf/cm applied. Referring to FIG. 5, the extreme pressure test performed with a 0.1 wt % fullerene added shows an increased load of up to 270 kgf/cm² applied, when friction at a portion of the metal raised the temperature. Referring to FIG. 6, the extreme pressure test performed with a 0.01 wt % fullerene added shows an increased abrasion resistance up to around 270 kgf/cm² of pressure, when there was little friction created, resulting in a relative drop in temperature at the lubricated portions.

Therefore, it is apparent that adding less than a 1.0 wt % fullerene results in increased extreme pressure tolerance.

The formula, k=[q/{4π(T₂-T₁)}]*In(t₂/t₁) is used to calculate the change in heat conductivity of refrigerating machine oil when fullerene is added [Nagasaka, 1984], where “k” is the heat conductivity of the liquid, “q” is energy of heat rays over a unit of length, “t” is a measured time, and “T” is the temperature of the heat rays over time “t”.

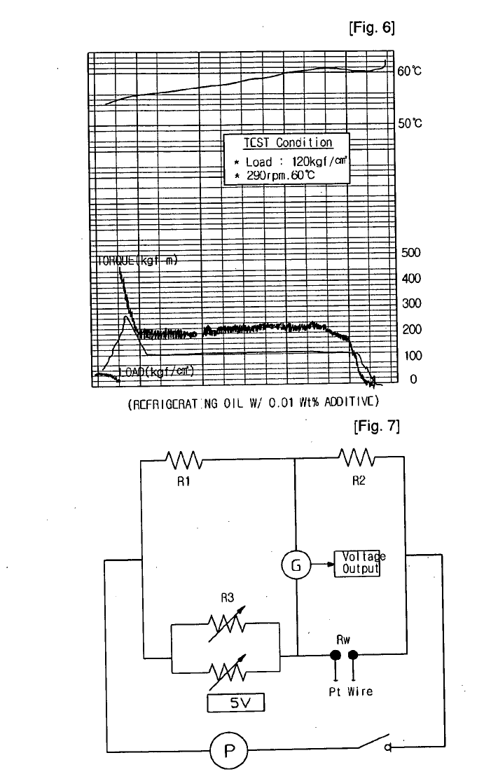

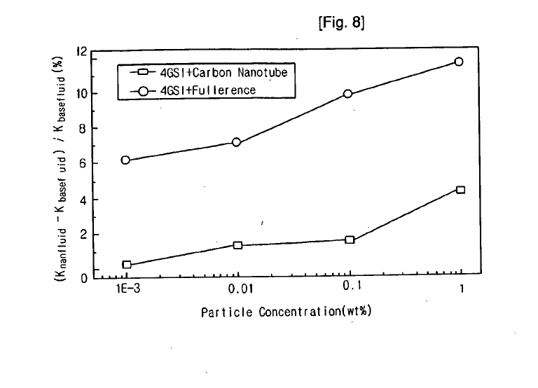

FIG. 7 is a rough circuit diagram for measuring heat conductivity of oil according to mixed percentages of fullerene, and FIG. 8 is a graph showing heat conductivity of oil mixed with fullerene and carbon nanotubes.

Referring to FIG. 7, “G” is a galvanometer, and “P” is a power supply. Looking at how measurements are taken by this structure, power is supplied after the variable resistance is adjusted so that the initial value is 0. As temperature rises along a platinum (pt) wire according to the wire's resistance, the resistance increases accordingly, so that a change in the voltage at the galvanometer occurs. The change in resistance of the pt wire is calculated from the change in voltage, and temperature fluctuation data can be derived from the temperature-resistance curve. Likewise, heat conductivity can be calculated from the temperature fluctuation and the heat flux of the Pt wire.

Referring to FIG. 8, through the above measurement and calculation technique, we can see how the addition of a nano particulate such as fullerene to refrigerating machine oil can increase the heat conductivity of the oil. As shown in the graph, the heat conductivity of a fullerene compound is remarkably high when compared to that of a carbon nanotube compound.

When heat conductivity of refrigerating machine oil is increased, heat dissipation from the compressor increases, and the refrigerating machine oil transfers heat more readily while circulating with the coolant through the coolant passages, improving heat exchange efficiency of the entire refrigerating cycle.

The present invention is not limited to the preferred embodiments described herein; and it will be apparent to those skilled in the art that various modifications and variations can be made therein without departing from the spirit and scope of the invention.

It is therefore intended that the present invention not only covers the described embodiment of a carbon nano particulate, being fullerene, added to a refrigerating machine oil, but also nano-sized materials, such as carbon nanotubes and graphite.

### INDUSTRIAL APPLICABILITY

Compared to conventional refrigerating machine oil, the refrigerating machine oil of the present invention for a compressor noticeably increases abrasion resistance, ability to withstand extreme pressures, and heat conductivity, and therefore has a wide industrial applicability.

1. A refrigerating machine oil for a compressor comprising:
a lubricating oil applied on frictional surfaces to reduce friction thereon; and
less than 1.0 wt % of carbon nano particulate.

2. The refrigerating machine oil according to claim 1, wherein the percentage by weight of the carbon nano particulate is less than 0.1%.

3. The refrigerating machine oil according to claim 1, wherein the carbon nano particulate is C₆₀ or C₇₀ fullerene.

4. The refrigerating machine oil according to claim 1, wherein the carbon nano particulate is a carbon nanotube particulate.

5. The refrigerating machine oil according to claim 1, wherein the carbon nano particulate is graphite.

6. The refrigerating machine oil according to claim 1, wherein the oil for a compressor is manufactured using an ultrasonic dispersion.
